(19) United States
(12) Patent Application Publication
(10) Pub. No.: US 2016/0053841 A1
(43) Pub. Date: Feb. 25, 2016

(54) BUSHING AND OSCILLATION-DAMPING CONNECTION ARRANGEMENT

(71) Applicant: FORD GLOBAL TECHNOLOGIES, LLC, Dearborn, MI (US)

(72) Inventors: Michael Georg FIGURA, Dormagen (DE); Christoph MEIER, Köln (DE)

(73) Assignee: FORD GLOBAL TECHNOLGIES, LLC, Dearborn, MI (US)

(21) Appl. No.: 14/831,284

(22) Filed: Aug. 20, 2015

(30) Foreign Application Priority Data
Aug. 21, 2014 (DE) 102014216670.5

(51) Int. Cl. F16F 1/38

(52) U.S. Cl. CPC F16F 1/38

(57) ABSTRACT

A bushing for the oscillation-damping connection of two components such as a vehicle frame or vehicle structure and a steering gear is disclosed. The bushing includes an inner bearing element having first and second ends. An opening extends through the first end of the inner bearing element in a longitudinal direction. The inner bearing element includes a support face on the first end. A resilient member at least partially surrounds the inner bearing member. At least a portion of the resilient member extends below the support face in the longitudinal direction. The bushing also may include an outer bearing element, such that the resilient member is positioned between the inner and outer bearing elements.

### CROSS REFERENCE TO RELATED APPLICATIONS

This application claims priority to German Application No. 10 2014 216 670.5, filed on Aug. 21, 2014, the entire content of which is incorporated by reference herein.

### TECHNICAL FIELD

The present disclosure relates generally to a bushing for the oscillation-damping connection of two components, in particular the connection of a vehicle frame or vehicle structure to a steering gear.

### BACKGROUND

Oscillations which occur both during the operation of stationary machines and in the case of vehicles which are moving may be perceived as audible noises or perceptible vibrations. These are generally combined under the abbreviated term NVH (Noise, Vibration, Harshness). In vehicle construction, it is desirable to separate the oscillations which are sometimes desired from those which are undesirable. Structural members and/or components which are producing or transmitting the undesirable oscillations are intended to be decoupled in an appropriate manner. For this purpose, isolating elements are used in the connection regions thereof to prevent or at least reduce a structural transmission of the oscillations.

The connection arrangements to be established between the structural members and/or components may be both movable and non-movable connections. Movable connections appear, for example, in the coupling of suspension structural members, such as, for example, links or a torsion beam axle to the vehicle structure or frame. Non-movable connections are used between components which are fixed relative to each other, such as, for example, for the connection of a steering gear to a vehicle frame or vehicle structure. In both types of connections, bushes or bushings, also known as rubber bushings, may be used. These are mostly constructed as composite bearings, though other configurations are also possible.

Such conventional composite bearings may be subjected to undesirable torsion when, for example, a screw type of connection is used to connect components, the screwing requiring a torque which loads the resilient portion of the bearing. In particular, torsion of an inner bearing element may occur when the screw is tightened and may result in the permanent loading of the resilient portion. Such permanent loading of the resilient portion of the bearing (by rotation thereof) can reduce or impair the desired isolating effect of the resilient portion and also can reduce or impair the durability of the resilient portion and thus the bearing.

In order to prevent the undesirable preloading of the resilient portion, it is necessary to arrange on the inner bearing element a contact face via which a contact with a suitable tool can be produced. It is thereby possible accordingly to resist the torque which has to be applied to the connection screw so that no torsion of the inner bearing element is carried out. Nonetheless, the structural spaces which are associated with the structural members and/or the components which are intended to be arranged are occasionally sized to be so small that they actually do not allow sufficient space for the use of an additional tool, such as a wrench.

Accordingly, it is clear that the local conditions occasionally do not allow any possibility for forming a connection arrangement with a resilient portion which is not pre-tensioned by torsion and, even when there are sufficient spatial relationships, the connection complexity is increased in a generally disadvantageous manner by the necessity to use another tool.

Against this background, a bushing and a connection arrangement having a bushing for the oscillation-damping connection of two components in such a manner that the connection, in spite of the application of a torque, can be produced without the need for a tool which is used for resistance is desirable.

### SUMMARY

In accordance with various exemplary embodiments, the present disclosure provides a bushing, comprising an inner bearing element having first and second ends, an opening extending through the first end of the inner bearing element in a longitudinal direction, the inner bearing element including a support face on the first end, and a resilient member at least partially surrounding the inner bearing member; wherein at least a portion of the resilient member extends below the support face in the longitudinal direction.

In accordance with another aspect of the present disclosure, a bushing comprises an inner bearing element having first and second ends, an opening extending through the first end of the inner bearing element in a longitudinal direction, the inner bearing element including a support face on the first end, an outer bearing element, and a resilient member positioned between the inner and outer bearing members and at least partially surrounding the inner bearing member.

Additional objects and advantages of the present disclosure will be set forth in part in the description which follows, and in part will be obvious from the description, or may be learned by practice of the present disclosure. Various objects and advantages of the present disclosure will be realized and attained by means of the elements and combinations particularly pointed out in the appended claims.

It is to be understood that both the foregoing general description and the following detailed description are exemplary and explanatory only and are not restrictive of the present disclosure.

The accompanying drawings, which are incorporated in and constitute a part of this specification, illustrate embodiments of the present disclosure and together with the description, serve to explain the principles of the present disclosure.

### BRIEF DESCRIPTION OF THE DRAWINGS

At least some features and advantages will be apparent from the following detailed description of embodiments consistent therewith, which description should be considered with reference to the accompanying drawings, wherein:

FIG. 1 is a sectioned illustration of an oscillation-damping connection arrangement according to the present disclosure, and

FIG. 2 shows a detail of the oscillation-damping connection arrangement from FIG. 1 in the non-connected state.

Although the following detailed description makes reference to illustrative embodiments, many alternatives, modifications, and variations thereof will be apparent to those skilled in the art. Accordingly, it is intended that the claimed subject matter be viewed broadly.

### DESCRIPTION OF THE EMBODIMENTS

Reference will now be made in detail to various embodiments, examples of which are illustrated in the accompanying drawings. However, these various exemplary embodiments are not intended to limit the disclosure. To the contrary, the disclosure is intended to cover alternatives, modifications, and equivalents. In the drawings and the description, similar elements are provided with similar reference numerals. It is to be noted that the features explained individually in the description can be mutually combined in any technically expedient manner and disclose additional embodiments of the present disclosure.

In accordance with the present teachings a bushing which is suitable for the oscillation-damping connection of two components is provided. In accordance with one aspect of the present disclosure, the bushing disclosed herein (also referred to as a bearing bush, a bush, or a bush bearing) can be used for the oscillation-damping connection of a frame or structure of a vehicle to a steering gear.

To this end, the bushing comprises an inner bearing element and a resilient support member. The resilient support member may, for example, be an elastomer material or the support member may comprise such a material in combination with other material(s). In one exemplary embodiment, the resilient support member may be formed from rubber or at least comprise rubber in combination with other material(s). The inner bearing element, which may be harder than the resilient support member, has an opening which extends between two opposing ends of the inner bearing element. The opening may be configured to receive an element, such as a connection element, for example a screw. The opening extends in a longitudinal direction of the inner bearing. In accordance with one exemplary embodiment, the two ends of the inner bearing element can be opened in such a manner that the opening extends through the entire inner bearing element. In this regard, the opening could also be referred to as a through-opening. However, in accordance with an alternative exemplary embodiment, it also is possible to keep the opening closed at one end of the inner bearing element, that is to say, for example, to construct the opening as a blind-hole opening.

In accordance with another aspect of the present disclosure, the inner bearing element is at least partially surrounded by the resilient support member at the peripheral side.

In accordance with one exemplary embodiment, the inner bearing element may be formed from a metal. The inner bearing element may be made, for example, of steel or aluminum. Other suitable materials will be apparent to those of ordinary skill in the art.

In accordance with the present disclosure, the inner bearing element has an inner thread which is arranged at least partially inside the opening of the inner bearing element. One of the two ends of the inner bearing element has an end-face support face by means of which the inner bearing element can be brought into contact with a surface region of one of the components which are intended to be connected to each other.

The component mentioned may thus have, for example, a through-opening, through which a connection screw can be arranged. After it has passed through the component, the connection screw can then be introduced into the opening of the inner bearing element. Via a corresponding outer thread which is arranged on the connection screw, the connection screw can then be moved into engagement with the inner thread of the opening of the inner bearing element. When the connection screw is tightened, the inner bearing element is moved toward a surface region of the component, which region is located around the continuous opening within the component and against which it can ultimately be supported by means of the support face thereof which is arranged at the end face on the inner bearing element.

The resilient support member is constructed in such a manner that increased friction in the region of the support face of the inner bearing element is enabled. To this end, at least a portion of the resilient support member protrudes beyond the support face so that the resilient support member has at least one protuberance. The protuberance extends parallel with the longitudinal direction of the opening of the inner bearing element so that the protuberance forms the first region of the bushing, which region can be brought into contact with the component described above. The at least one protuberance at least partially surrounds to the support face of the inner bearing. In one exemplary embodiment, the at least one protuberance is a single protuberance that extends at least partially around the support face. Additionally or alternatively, the single protuberance may extend to completely surround the support face. In accordance with another exemplary embodiment, the at least one protuberance includes a plurality of protuberances, each of which extends below the support face of the inner bearing and together at least partially surround the support face. Additionally or alternatively, the plurality of protuberances may extend to completely surround the support face and may be positioned directly adjacent to one another or spaced apart from each other.

The at least one protuberance forms an anti-rotation device which is constructed in a simple manner and which comprises at least one protruding portion of the resilient support member. During the tightening operation, the protuberance moves into contact with the surface region of the component to be connected, even before the support face of the inner bearing element can be placed on the component. In this manner, the friction, which is increased as a result of the resilient material of the support member, is used in order to secure the inner bearing element of the bushing with respect to torsion created by the torque which is intended to be applied to secure the component to the bush bearing.

As a result of the protuberance of the resilient support member, which protuberance is arranged directly in the region of the support face of the inner bearing element, the inner bearing element is supported on the component by means of the protuberance of resilient material which is located between the support face of the inner bearing element and the surface of the component. The torque which is transmitted from the connection screw to the inner bearing element via the threads of the connection screw and the inner bearing element, which are in engagement with each other, can consequently be resisted as a result of the inhibiting action of the protuberance of resilient material.

Consequently, there is no unfavorable co-rotation of the inner bearing element when the connection screw is tightened, which co-rotation would otherwise lead to undesirable torsion of the resilient support member. In addition, there is no need for an additional tool in order to counteract the torque which is applied to the connection screw directly on the inner bearing element. Furthermore, depending on the configuration of the resilient protuberance, a sealing action is produced and protects the connection location against the introduction of contamination and/or fluids, such as salt water. In particular, surface regions of the component which are intended to be introduced, which surface regions are not intended to be damaged by contact, can be protected by the protruding protuberance to a sufficient degree as a result of the spacing of the support face which is maintained.

According to another aspect of the present disclosure, the bushing also may comprise an additional outer bearing element. The inner bearing element is at least partially arranged inside the outer bearing element. The arrangement of the two bearing elements one inside the other is carried out with at least partial introduction of the resilient support member. In this manner, the two bearing elements are spaced apart from each other as a result of the resilient support member and isolated and at the same time mechanically connected to each other. The intensity of the connection is in this instance significantly dependent on the resilient properties of the support member, a soft construction enabling a correspondingly highly isolated and sometimes movable connection. In accordance with one exemplary embodiment, the rubber material of the resilient support material is vulcanized to the metal of the inner and outer bearing elements. It is also possible to connect the inner and outer bearing elements and the resilient support member by means of a press-fit.

As will be understood by those of ordinary skill in the art, the strength of the resilient support member may be varied through selection of, for example, the material of the support member and/or the thickness of the support member. Exemplary materials from which the resilient support member may be made include, for example, natural rubber (NR), nitrile (acrylonitrile-butadiene rubber or NBR), and hydrogenated nitrile (hydrogenated acrylonitrile-butadiene rubber or HNBR). The desired strength of the resilient support member may be selected, for example, based on the desired decoupling and/or the forces to be transmitted. As will also be understood by those of ordinary skill in the art, the thickness of the support member between the two bearing elements can be varied such that the two bearing elements are spaced further apart from each other as the thickness of the support member increases.

In accordance with one aspect of the present disclosure, the outer bearing element may have a hardness greater than that of the resilient support member. The outer bearing element may be made, for example, of steel or aluminum. Other suitable materials will be apparent to those of ordinary skill in the art. As a result, the bushing may have a fixed outer contour, via which the arrangement can be carried out, for example, within a corresponding opening of one of the components which are intended to be connected to each other. Advantageously, the bushing may be pressed in such a manner via the outer bearing element into the opening of one of the components to be connected. In this manner, the bushing can be arranged in the component in a torsion-resistant manner.

The component referred to here is the component which does not have a receiving opening for the connection screw. Of course, the bushing also can be arranged in the mentioned component without the external bearing element so that it is arranged directly via the resilient support member inside the opening of the component. In this manner, but also as with the outer bearing element being introduced, the bearing element may, for example, be adhesively bonded in the opening of the component.

According to the present teachings, the end of the inner bearing element which has the support face has a radially protruding collar. The term radially protruding is intended to be understood to mean that the collar extends outwardly away from the opening in the inner bearing element. In this regard, the collar may be described as an end-side cross-sectional branch of the inner bearing element, which branch extends beyond the outer diameter of the remaining inner bearing element. The collar may be connected to the inner bearing element as an additional component. Additionally or alternatively, the collar may be of the same material as the inner bearing element and may be formed as an integral component part of the inner bearing element.

The present disclosure contemplates that the collar may be surrounded at least partially by the resilient support member. In one exemplary embodiment, the collar may be embedded completely inside the resilient support member. At the same time, the collar itself or the collar together with the associated end of the inner bearing element provides the end-face support face.

The support face is arranged at an end face of the collar or the collar together with the end of the inner bearing element forms the support face, which end face faces away from the opposing end of the inner bearing element. To this end, the collar may be constructed in a manner similar to a continuous ring, which terminates at the end side flush with the associated end of the resilient support member.

The resulting support face, which may be planar, enables a corresponding distribution of the pressing force, as a result of the size of the collar, which is applied by the connection screw to the associated component. As the size of the support face increases, the mutual tilting resistance of the components which are connected to each other in this manner also increases.

According to the present disclosure, the collar is arranged at the end of the inner bearing element which has the support face and has a peripheral recess. In one exemplary embodiment, the recess may be formed in the region of a free end of the collar. In the case of an annular configuration of the collar, the recess may extend over the entire peripheral length of the collar. In another exemplary embodiment, the recess may extend between an outer periphery of the collar and the support face so that a corner region which is located between them is almost hollow.

The present disclosure contemplates that the resilient support member may be placed in this recess. Accordingly, the resilient support member, starting from a side of the collar remote from the support face, may extend around the outer periphery of the collar and at least partially extend into the recess. The engagement of the resilient support member in the recess may be carried out at the same time as the protrusion of the resilient support member is formed. Accordingly, the resilient support member may be thickened in the region of the recess in such a manner that it is placed into the recess in one direction and at the same time protrudes beyond the support face in the opposite direction as a protuberance.

In another exemplary embodiment, the collar may have an annular or disk-like configuration and the recess may extend completely around the periphery thereof, the protuberance of the resilient support member having the shape of an annular lip or an annular bead.

As a result of the arrangement of the recess, the protrusion of the resilient support member is thickened in a location behind the plane of the support face so that a space which provides sufficient compressibility of the protrusion is produced. That is to say, when the recess is dispensed with, the protrusion sometimes does not have sufficient space to be sufficiently compressed when the connection screw is tightened. As a result of the recess, the protrusion can be completely resiliently displaced therein so that, between the support face of the inner bearing element and the surface of the component which is intended to be introduced, it is possible, for example, for a flat contact to be adjusted.

In accordance with another aspect of the present disclosure, the outer bearing element may have a flange which extends radially away from the inner bearing element. The flange may be connected to the outer bearing element as a separate or additional component. Additionally or alternatively, in one exemplary embodiment, the flange may be made of the same material as and formed as an integral component of the outer bearing element. The flange may be arranged at an end of the outer bearing element, which end faces the collar of the inner bearing element. Accordingly, the collar and flange of the respective bearing elements face each other. In order to achieve adequate decoupling between the two bearing elements, they are advantageously spaced apart from each other. In one exemplary embodiment, the flange of the outer bearing element may be spaced apart from the collar of the inner bearing element by the resilient support member, which is introduced between the flange and the collar. Additionally, the flange and the collar may extend in parallel to one another, in a direction radially outward from the longitudinal opening of the inner bearing element.

As a result of the facing bearing elements which are isolated from each other by means of the resilient support member, a high level of positional precision of the outer bearing element with respect to the inner bearing element is achieved. While the inner bearing element can be supported against the associated component by means of the support face thereof, a load which is produced in the longitudinal direction from the other component can accordingly advantageously be transmitted directly by means of a compression or extension of the resilient support member which is located between the flange and collar. Shearing stresses of the resilient member between the corresponding peripheral faces of the bearing elements which are arranged at least partially one inside the other are thereby reduced.

As already set out above, the bushing of the present disclosure can, for example, be adhesively bonded or pressed into an associated opening of a component. Accordingly, the bushing may then have a materially integral and/or non-positive-locking and/or positive-locking connection to the associated component.

According to another aspect of the present disclosure, the outer bearing element of the bushing may have an outer thread which is at least partially arranged thereon. This enables another type of connection of the bushing to the respective component. The outer thread can be used to screw the bushing into an opening of the associated component, which opening has a corresponding inner thread. Of course, this type of connection also may be supplemented by at least one additional connection, for example, by an adhesive bonding. This also may be constructed in such a manner that the adhesive bonding constitutes only a securing of the screw connection. In this regard, it is contemplated that the connection between the component and the bushing may be releasable by means of unscrewing the bushing. The releasable screwable connection of the bushing enables extremely simple maintenance and flexibility.

In order to achieve the strongest possible connection between one of the bearing elements or both bearing elements to the resilient support member, these may, for example, initially be formed as separate parts and be subsequently connected to each other in a positive-locking manner. Additionally or alternatively, they also may be connected to each other by means of adhesive bonding. For instance, the adhesive used may, in the non-hardened state, first enable the individual parts to be introduced one into the other in a manner which is simple because it involves sliding, the actual connection taking place only after the adhesive has hardened.

In one exemplary embodiment, the material for the resilient support member may be a rubber which may be vulcanized between the inner bearing element and the outer bearing element. This enables a simple production of the bushing, in which the resilient support member, as an initially shapeless material with plastic properties, is introduced between the two bearing elements and is subsequently brought to the definitive shape thereof and vulcanized. In this instance, the plastic properties thereof are lost in favor of the desired resilient properties thereof so that sufficient isolation with respect to the transmission of oscillations is produced.

In order to produce the most durable possible connection of the bushing to the component which is intended to be introduced, the present disclosure contemplates that the support face of the bushing to be able to have an at least partially structured surface. The term “structured” in this instance is intended to mean not a purely visually identifiable structure, but instead a haptically perceptible structure. As a result of the structure, the roughness of the surface of the support face is increased so that a connection with increased friction can be produced. Of course, the structure may be constructed in such a manner that, when the connection screw is tightened, it is pressed at least partially into the surface of the associated component. In addition to the non-positive-locking connection, a positive-locking connection is also thereby produced between the bushing and the component which is intended to be introduced.

Even if the inner bearing element and/or the outer bearing element may have different forms, it may be advantageous for the inner bearing element and/or the outer bearing element to be constructed in a sleeve-like manner. The outer bearing element may thus be constructed as a sleeve or at least partially have a sleeve-like shape. The inner bearing element may also be constructed as a sleeve or at least partially have a sleeve-like shape. With particular regard to an annular construction of the collar which is arranged on the inner bearing element, it is considered to be particularly advantageous for the protrusion of the resilient support member to extend at least partially in an annular manner around the support face. In one exemplary embodiment, the support face may be completely surrounded by the protrusion so that an at least initial peripheral contact with respect to the component which is intended to be introduced is produced purely with respect to the protuberance. From a specific progress state in the construction of the connection, the support face may then move into contact with the surface of the associated component by means of further resilient displacement of the protuberance.

A bushing in accordance with the present teachings enables the production of an oscillation-damping connection of two components which can be produced despite the application of a torque, without the need for a tool which is used for resistance. It is thereby possible for the bushing of the present disclosure to be used under local conditions which, when conventional bushings are used, occasionally do not afford any possibility for the production of a connection arrangement with a resilient support member which is not preloaded by mean of torsion.

Even if the spatial relationships which are provided may be considered to be sufficient, and consequently the use of an additional tool used for resistance would be possible, the fact that there is no need to use another such tool results in significantly reduced connection complexity. This applies to both the production and the release of such a connection.

The present disclosure is further based on an oscillation-damping connection arrangement which serves to connect two components. The two components may be, for example, a vehicle frame or vehicle structure and a steering gear which is intended to be connected thereto. To this end, the connection arrangement comprises a connection screw and a bushing which is provided for torsion-resistant arrangement in a first of the components. The bushing which is used in this instance may be the above-described bushing in accordance with the present teachings.

As disclosed herein, the bushing has at least one inner bearing element which is at least partially surrounded by a resilient support member and which has an opening which extends between the ends thereof in the longitudinal direction and which is configured to at least partially receive the connection screw at the same time as the second of the components is introduced.

According to the present teachings, an inner thread is arranged at least partially inside the opening of the inner bearing element and can be moved at least partially into engagement with an outer thread of the connection screw. Furthermore, one of the ends of the inner bearing element has an end-face support face. The resilient support member protrudes at least partially with respect to this support face, with at least one protuberance which is orientated parallel with the longitudinal direction being formed in such a manner that the bushing, when the components are screwed by means of the connection screw, with the protuberance being at least partially pressed, can be supported against a surface region of the second component which can be introduced, which surface region faces the bushing.

The advantages resulting from this have already been explained in greater detail in connection with the bushing of the present disclosure and apply accordingly to the oscillation-damping connection arrangement according to the present teachings. For this reason, reference is made here to the previous explanations.

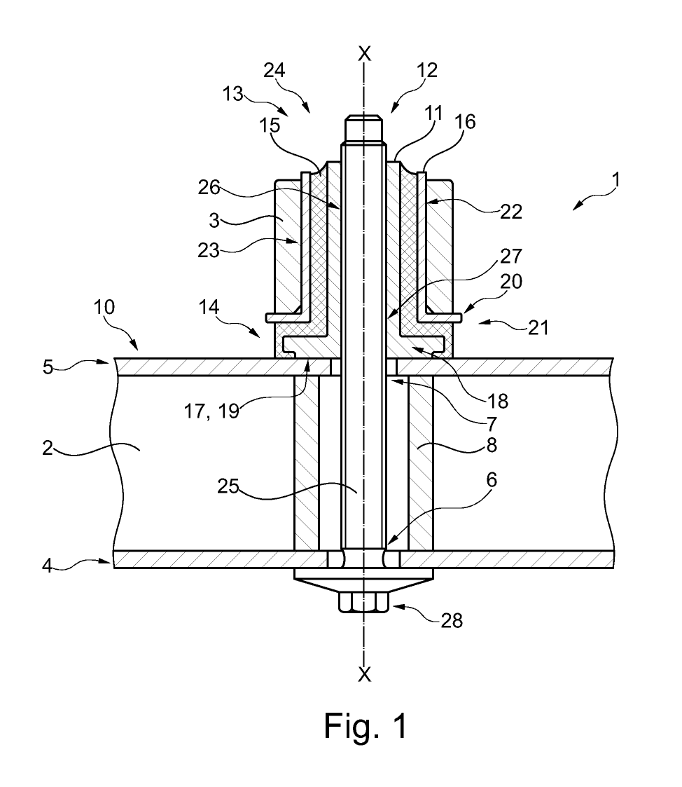

Turning now to the drawings, FIG. 1 is a schematic illustration of an oscillation-damping connection arrangement 1 according to the present disclosure. This serves to connect at least two components (2, 3) to each other. In this instance, the two components (2, 3) are illustrated only as a cut-out for reasons of clarity in the manner indicated. The two components (2, 3) which are indicated here are a vehicle frame 2 or vehicle structure of a vehicle which is not shown in greater detail and a steering gear 3 which is connected to the vehicle frame 2.

The portion of the vehicle frame 2 shown here is composed of two frame shells 4, 5 which are connected to each other; more specifically, a lower frame shell 4 which is indicated at the bottom in FIG. 1 and an upper frame shell 5 which is indicated at the top. Each frame shell 4, 5 has an opening 6, 7—a lower opening 6 is arranged in the lower frame shell 4 and an upper opening 7 is arranged in the upper frame shell 5. In the region of the mentioned openings 6, 7, a stabilizing element 8 which is constructed in this instance as a pipe extends between the two frame shells 4, 5.

Above the upper frame shell 5, it is possible to see a bushing 9 according to the present disclosure. Bushing 9 is in abutment with a surface region 10 of the upper frame shell 5. The bushing 9 comprises a sleeve-like inner bearing element 11 having an opening 12 configured to receive a connection element such as, for example, a screw. In the embodiment illustrated, the opening 12 is open at both ends of the bushing and could thus also be referred to as a through-opening 12. It also is possible for the opening 12 to be constructed so as to be closed at one end, that is to say, for example, to be constructed as a blind hole. The inner bearing element 11 has an upper end 13 in the plane of projection and a lower end 14 which is opposite the upper end 13 and which faces the surface region 10 of the upper frame shell 5 in the plane of projection. As can be seen in FIG. 1, the opening 12 extends in the longitudinal direction x between the two ends 13, 14 and completely through the inner bearing element 11. If the opening 12 were closed at one end, the opening would also extend in the longitudinal direction x between the two ends 13, 14 but be closed at the end 13 or at a location within the inner bearing element. The inner bearing element 11 is further surrounded at the peripheral side by a resilient support member 15.

The bushing 9 further has an outer bearing element 16 which is also sleeve-like, the inner bearing element 11 being arranged at least partially inside this outer bearing element 16. In this arrangement, the resilient support member 15 is introduced between the bearing elements 11, 16 at least between the portions of the two bearing elements 11, 16 which extend parallel with each other. As can be seen, the inner bearing element 11 has at the lower end 14 thereof facing the surface region 10 of the upper frame shell 5 a front-side support face 17 via which the bushing 9 is supported against the surface region 10 of the introduced component 2 in the form of the vehicle frame 2. Preferably, the support face 17 may have a structured surface which is not shown in greater detail and which is arranged at least in regions. That is to say, at least portions of the support face 17 may be structured, or roughened or otherwise textured to create friction between the support face 17 and the surface on which it rests.

The lower end 14 of the inner bearing element 11 having the support face 17 has a radially protruding collar 18. As shown, the radially protruding collar extends outwardly away from the opening 12 in a direction substantially perpendicular to the direction X, the collar being constructed as a ring or disk. The collar is arranged at the end side around the inner bearing element 11 or at the lower end 14 thereof. The collar 18 is completely surrounded by the resilient support member 15. The support face 17 is arranged so as to be visible at an end face 19 of the collar 18, which face is directed away from the opposing upper end 13 of the inner bearing element 11.

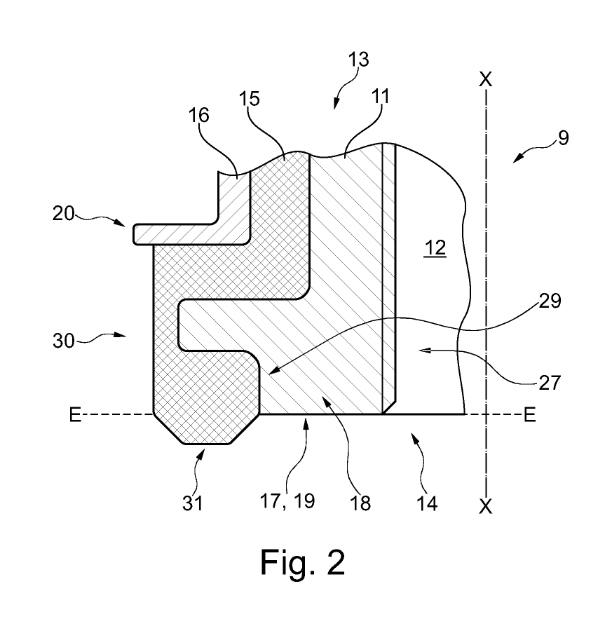

As shown, the outer bearing element 16 has a flange 20 which extends radially away from the inner bearing element 11. The flange 20 is arranged at an end 21 of the outer bearing element 16 facing the collar 18 of the inner bearing element 11. The flange 20 and collar 18 of the two bearing elements 11, 16 are spaced apart from each other, incorporating a portion of the resilient support member 15 therebetween. The resilient support member 15 may be vulcanized between the inner bearing element 11 and the outer bearing element 16. As shown in FIGS. 1 and 2, portions of the flange 20 and collar 18 may extend outwardly from the center of the bush bearing 9, in a direction substantially perpendicular to direction X, the flange 20 and collar 18 extending substantially parallel to one another with a portion of the resilient support member 15 being positioned therebetween.

The outer bearing element 16 may have an outer thread 22 which is not shown in greater detail here and which is at least partially arranged on an external or outer surface of the outer bearing element 16 (and thus the outer surface of bushing 9). By means of this, the bushing 9 can be screwed into an opening 24 of the component 3, which opening has a corresponding inner thread 23, in the form of the steering gear 3. Independently of this, the bushing 9 can also be adhesively bonded and/or pressed into the opening 24 of the steering gear 3. In this case, the bushing 9 is arranged in a torsion-resistant manner inside the opening 24 of the steering gear 3.

As shown in FIG. 1, the actual connection between the two components 2, 3 may be carried out by means of a connection screw 25. Connection screw 25 extends through the two openings 6, 7 of the vehicle frame 2 and is introduced into the opening 12 of the inner bearing element 11. The connection screw 25 has an outer thread 26 which cannot be seen in greater detail. In contrast, the inner bearing element 11 has an inner thread 27 which also cannot be seen in greater detail and which is arranged inside the receiving opening 12 thereof. The inner thread 27 of the opening 12 and the outer thread 26 of the connection screw 25 are in engagement with each other so that, by applying a torque to a head 28 of the connection screw 25 opposite the bushing 9, a movement of the bushing 9 toward the vehicle frame 2 and a corresponding construction of the connection are possible. In FIG. 1, it can be seen that the connection screw 25 protrudes from the opening 12. It will be understood that the screw 25 would not protrude in such a manner when opening 12 is closed at one side, that is to say opening 12 is formed by, for example, a blind-hole opening.

FIG. 2 shows a detailed cut-out of the bushing 9 from FIG. 1 in the non-installed state. It is possible to see in particular a portion of the inner bearing element 11 with the collar 18 thereof and a portion of the outer bearing element 16 with the flange 20 thereof. It is further possible to see a portion of the resilient support member 15 which is introduced between the two bearing elements 11, 16. The inner thread 27 which is arranged inside the opening 12 is further indicated.

In this illustration, it can be seen that at the lower end 14 of the inner bearing element 11 having a collar 18, which lower end has the support face 17, a continuous recess 29 is arranged. The recess 29 extends between an outer periphery 30 of the collar 18 and the support face 17. In this region, a portion of the resilient support member 15 protrudes, with respect to a plane E of the support face 17, with a protuberance 31 which is oriented parallel with the longitudinal direction X. In this instance, a portion of the resilient support member 15 engages in the recess 29 of the collar 18 resulting in the formation of the protuberance 31. The protuberance 31 may be constructed in a continuous manner so that it extends in an annular manner around the support face 17. Additionally or alternatively, the protuberance 31 may not be constructed continuously, such that protuberance 31 includes multiple protuberances distributed around the perimeter of support face 17.

During the screwing of the two components 2, 3 which is not shown in greater detail here and which can already be seen in FIG. 1 via the connection screw 25, the bushing 9, with the protuberance 31 being at least partially pressed, is supported against the surface region 10 of the vehicle frame 2 which is consequently introduced, which surface region faces the bushing 9.

Further modifications and alternative embodiments will be apparent to those of ordinary skill in the art in view of the disclosure herein. For example, the systems and the methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

This description and the accompanying drawing that illustrates exemplary embodiments of the present teachings should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Like numbers in two or more FIG.s represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “a sensor” includes two or more different sensors. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the system and method of the present disclosure without departing from the scope its disclosure. It is to be understood that the particular examples and embodiments set forth herein are non-limiting, and modifications to structure, dimensions, materials, and methodologies may be made without departing from the scope of the present teachings. Other embodiments of the disclosure will be apparent to those skilled in the art from consideration of the specification and practice of the disclosure disclosed herein. It is intended that the specification and embodiment described herein be considered as exemplary only.

What is claimed is:

1. A bushing, comprising:
an inner bearing element having first and second ends, an opening extending through the first end of the inner bearing element in a longitudinal direction, the inner bearing element including a support face on the first end; and
a resilient member at least partially surrounding the inner bearing member; wherein at least a portion of the resilient member extends below the support face in the longitudinal direction.

2. The bushing of claim 1, wherein the resilient member forms a protuberance that extends below the support face and at least partially in an annular manner around the support face.

3. The bushing of claim 1, wherein the inner bearing element further includes a radially extending collar, the collar positioned above the support face and being at least partially surrounded by the resilient support member.

4. The bushing of claim 3, further comprising a recess between a portion of the collar and the support face, wherein at least a portion of the resilient member extends within the recess.

5. The bushing of claim 4, wherein the opening extends through the first and second ends of the inner bearing element and is configured to receive a connection element.

6. The bushing of claim 1, wherein the resilient member that extends below the support face forms at least one protuberance configured to create friction between the bushing and a component to be connected to the bushing.

7. The bushing of claim 6, wherein the at least one protuberance includes a plurality of protuberances.

8. The bushing of claim 6, wherein the at least one protuberance is a single protuberance that extends in a continuous manner around a periphery of the support face and is configured to provide a sealing function.

9. The bushing of claim 6, further comprising an outer bearing element, wherein the resilient member is positioned between the inner and outer bearing elements.

10. The bushing of claim 9, wherein at least one of the inner bearing element and the outer bearing element forms a sleeve-like structure, wherein the at least one protuberance extends at least partially in an annular manner around the support face.

11. The bushing of claim 1, wherein the support face has a surface configured to create friction between the bushing and a component to be connected to the bushing.

12. A bushing, comprising:
an inner bearing element having first and second ends, an opening extending through the first end of the inner bearing element in a longitudinal direction, the inner bearing element including a support face on the first end;
an outer bearing element; and
a resilient member positioned between the inner and outer bearing members and at least partially surrounding the inner bearing member.

13. The bushing of claim 12, wherein the inner bearing element further comprises a radially extending collar adjacent to the first end.

14. The bushing of claim 13, wherein the outer bearing element has a flange which extends radially away from the inner bearing element and which is arranged at an end of the outer bearing element, wherein the flange is positioned above and spaced apart from the collar of the inner bearing element.

15. The bushing of claim 14, wherein the resilient member is positioned between the flange and the collar.

16. The bushing of claim 12, wherein an outer bearing element has an outer thread which is at least partially arranged thereon and wherein the opening of the inner bearing element has an inner thread.

17. The bushing of claim 12, wherein the resilient member is vulcanized between the inner bearing element and the outer bearing element.

18. The bushing of claim 12, wherein the resilient member extends below the support face of the inner bearing element and forms at least one protuberance that extends at least partially in an annular manner around the support face.

19. The bushing of claim 18, wherein the at least one protuberance is configured to create friction between the bushing and a component to be connected to the bushing.

20. The bushing of claim 18, wherein the at least one protuberance includes a plurality of protuberances.

21. The bushing of claim 20, wherein the at least one protuberance is a single protuberance that extends in a continuous manner around a periphery of the support face and is configured to provide a sealing function.
